(19) United States
(12) Patent Application Publication
(10) Pub. No.: US 2015/0047150 A1
(43) Pub. Date: Feb. 19, 2015

(54) MOVABLE BODY ASSISTANCE DEVICE

(71) Applicant: NIFCO INC., Yokohama-shi, Kanagawa (JP)

(72) Inventor: Norio Saito, Yokohama-shi (JP)

(73) Assignee: NIFCO INC., Yokohama-shi, Kanagawa (JP)

(21) Appl. No.: 14/386,240

(22) PCT Filed: Mar. 18, 2013
(86) PCT No.: PCT/JP2013/057731

§ 371 Date: Sep. 18, 2014

(30) Foreign Application Priority Data
Mar. 30, 2012 (JP) 2012-082754

(51) Int. Cl. E05D 15/06; E06B 3/46; E06B 3/34

(52) U.S. Cl. CPC E05D 15/0652; E05D 15/063; E06B 3/34; E06B 3/4636
USPC 16/103

(57) ABSTRACT

A movable body assist device includes a contact receiving body provided in one of a support body or a movable body relatively moving to the support body; a base body supported on a rail provided in one of the support body or the movable body relatively moving to the support body; a hanging wheel including a base provided in the other of the support body or the movable body and a roller supported in the base, and rotatably moving inside the rail, and suspending the other of the support body or the movable body movably on the rail; a contact body formed to swing in a first direction relative to the base body, and formed to engage with and disengage from the contact receiving body; an urging mechanism urging the contact body; and a connection portion connecting the base body to swing relative to the base of the hanging wheel.

### FIELD OF TECHNOLOGY

The present invention relates to a movable body assistance device for assisting an operation of various movable bodies.

### BACKGROUND ART

In order to assist the operation of a movable body such as a hanging door and the like, there is known a movable body assist device allowing the movable body to move by itself using an urging mechanism. In such movable body assist device, for example, in a rail attached to a door header, the movable body is hung and supported to run through a hanging wheel. Then, a contact receiving body is provided on a door header side; a closer is provided on a hanging door side; and a contact body engageable with the contact receiving body is provided inside a housing of the closer.

The contact body can slide between a standby position and a retracted position inside the housing, and is connected to a tensile coil spring as the urging mechanism. For example, the contact body includes an engagement portion at a tip, and the engagement portion can be engaged with and disengaged from the contact receiving body. Generally, one end of the housing is fixed to the movable body through the hanging wheel, and the hanging wheel and the housing are movably engaged inside the rail. Furthermore, on the other end of the housing, there is provided an auxiliary wheel running along the rail.

When the hanging door is in an open position, the contact body is held in the standby position in a state wherein the tensile coil spring is most stretched. When an operator moves the hanging door from the open position to a closed position, the contact body collides with the contact receiving body in a middle of the movement, and captures the contact receiving body. Simultaneously, retention of the contact body in the standby position is released, and while keep-capturing the contact receiving body, the contact body moves toward the retracted position by being pulled by the tensile coil spring. Consequently, the hanging door is forcibly moved for the moving distance.

When the hanging door is in the closed position, the contact body is in a state wherein the tensile coil spring is compressed. When an operator moves the hanging door toward the open position from the closed position, the hanging door is moved while pulling the tensile coil spring. When the hanging door reaches a predetermined position, the contact body opens the contact receiving body, and is held into the standby position again.

### PRIOR ART DOCUMENT

### Patent Document

Patent Document 1: Japanese Patent No. 4690026, Specification

### SUMMARY OF THE INVENTION

### Problems to be Solved by the Invention

In a structure wherein one end side of the housing is connected to the movable body through the hanging wheel, a load of the hanging door concentrates on a connection portion of one end, so that the other end of the housing lifts up from the rail, and the maintenance of a posture or position of the closer becomes difficult. The present invention has an object of providing a movable body assist device which can prevent the housing from being uplifted due to a load concentration.

### Means for Solving the Problems

According to the first aspect of the present invention, a movable body assist device comprises a contact receiving body provided in one of either a support body or a movable body relatively moving to the support body; a base body supported on a rail provided in one of either the support body or the movable body relatively moving to the support body; a hanging wheel including a base provided in the other of either the support body or the movable body, and a roller supported in the base and rotatably moving inside the rail, and suspending the other of either the support body or the movable body movably on the rail; a contact body formed to reciprocate in a first direction relative to the base body, and formed to engage with and disengage from the contact receiving body; an urging mechanism urging the contact body; and a connection portion connecting the base body to swing relative to the base of the hanging wheel.

According to a second aspect of the present invention, the movable body assist device comprises the contact receiving body provided in one of either the support body or the movable body relatively moving to the support body; the base body supported on the rail provided in one of either the support body or the movable body relatively moving to the support body; the hanging wheel including the base provided in the other of either the support body or the movable body, and the roller supported on the base and rotatably moving inside the rail, and suspending the other of either the support body or the movable body movably on the rail; the contact body formed to reciprocate in the first direction relative to the base body, and formed to engage with and disengage from the contact receiving body; the urging mechanism urging the contact body; and a connection portion having a deformable elastic portion, connecting the base body relative to the base of the hanging wheel, and by a deformation of the elastic portion, absorbing a displacement of the base.

According to a third aspect of the present invention, the movable body assist device comprises the contact receiving body provided in one of either the support body or the movable body relatively moving to the support body; the base body supported on the rail provided in one of either the support body or the movable body relatively moving to the support body; a hanging tool including the base provided in the other of either the support body or the movable body, and a hanging roller supported in the base and moving rotatably inside the rail, and suspending the other of either the support body or the movable body movably on the rail; the contact body formed to reciprocate in the first direction relative to the base body, and formed to engage with and disengage from the contact receiving body; and the urging mechanism urging the contact body. In a state wherein the base and the base body are integrally fixed, and the hanging roller and one end side of the base body spaced from the hanging roller in the first direction are supported on the rail, a center portion therebetween is formed to be curved in an arched shape in such a way as to be disposed by being spaced from the rail.

### Effect of the Invention

According to the present invention, the housing can be prevented from being lifted upwardly due to a load concentration.

### BRIEF DESCRIPTION OF THE DRAWINGS

FIG. 1 is an explanatory drawing showing an installation structure of an assist device according to the first embodiment of the present invention.

FIG. 2 is an explanatory drawing of the assist device according to the embodiment.

FIG. 3 is a perspective view showing one portion of the assist device according to the embodiment.

FIG. 4 is a cross-sectional view showing one portion of the assist device according to the embodiment.

FIG. 5 is an explanatory drawing of the assist device according to another embodiment.

FIG. 6 is an explanatory drawing of the assist device according to another embodiment.

### BEST MODES OF CARRYING OUT THE INVENTION

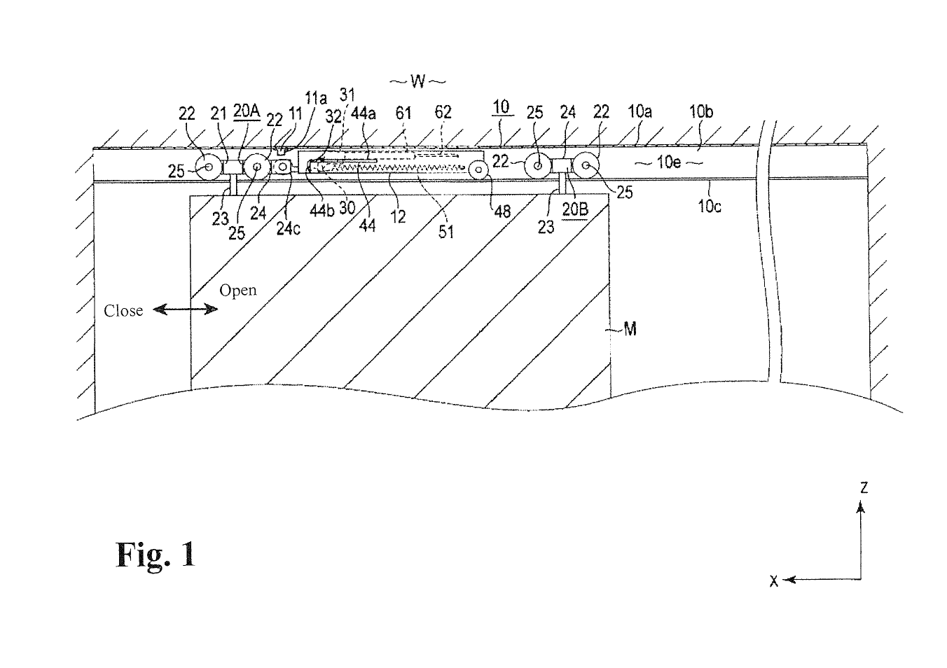

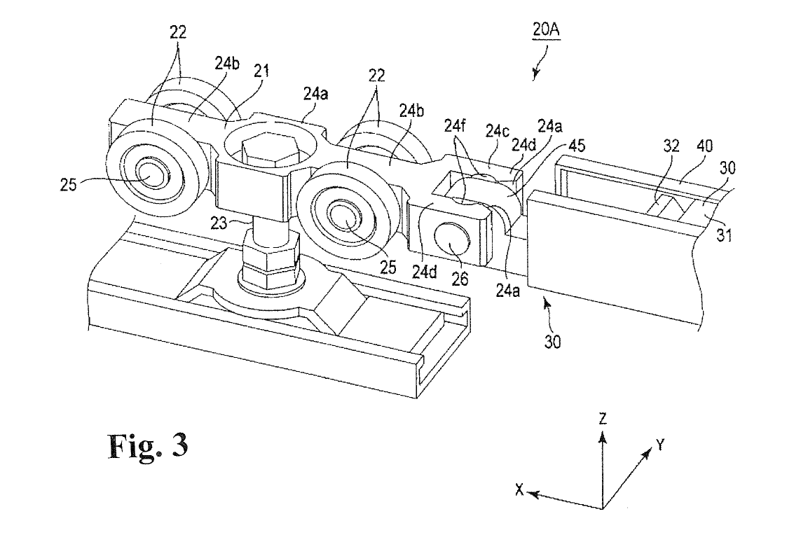

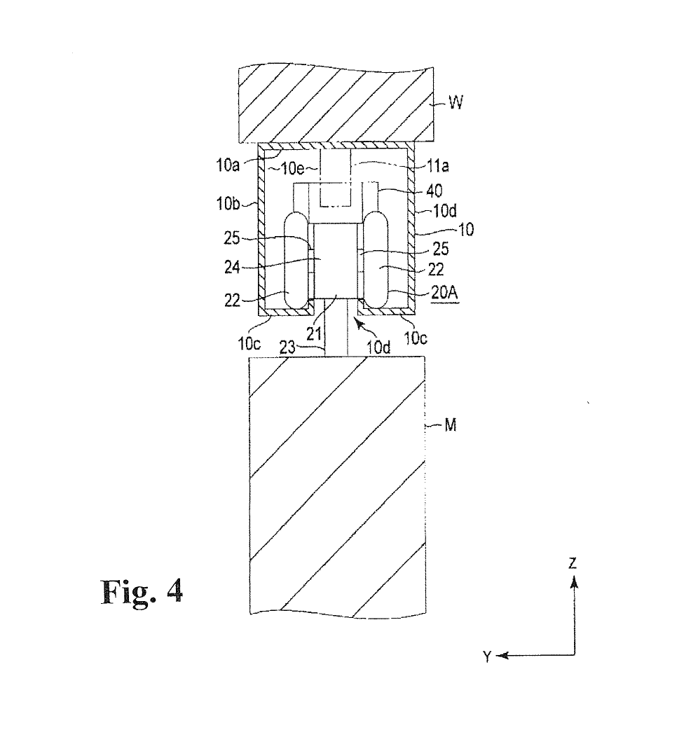

Hereinafter, a movable body assist device 1 according to one embodiment of the present invention will be explained with reference to FIG. 1 to FIG. 4. There, for example, an x axis runs along a slide direction; a Y axis runs along a width direction; and a z axis runs along an up-and-down direction, respectively. Also, for convenience of explanation, each drawing is shown by suitably enlarging, reducing, or omitting a structure.

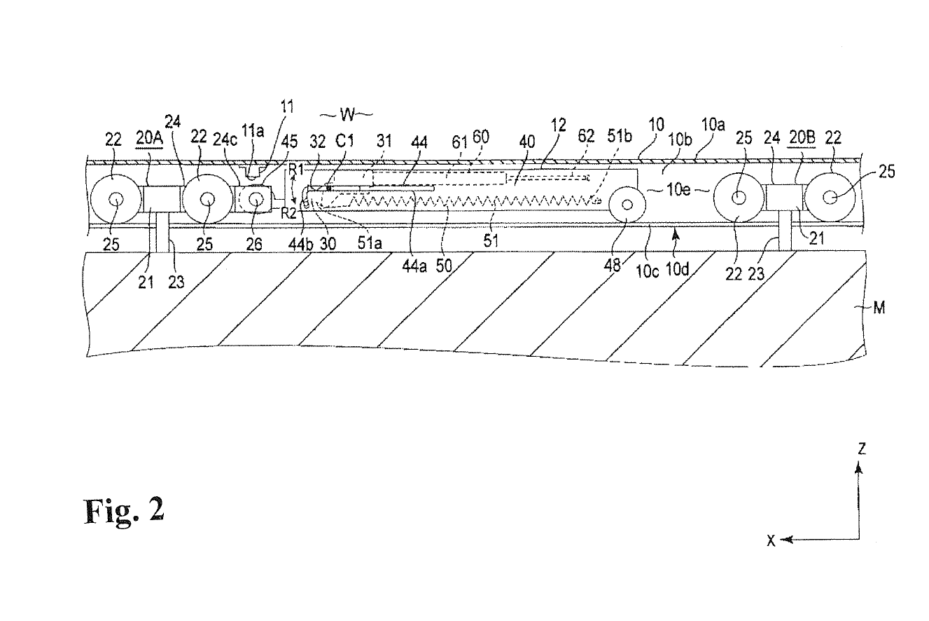

As shown in FIG. 1 and FIG. 2, the assist device 1 comprises a striker 11 as a contact receiving body provided in one of either a movable body or a support body, and a closer 12 provided in the other of either the movable body or the support body.

In the present embodiment, for example, the support body is a rail 10 installed in a door header W, and the movable body is a hanging door M. In the present embodiment, a case wherein the closer 12 is provided in the hanging door M as the movable body, and the striker 11 is provided in the rail 10 as the support body, will be shown as an example.

Incidentally, here, one hanging door M is thought, wherein one side is a door front end side, and the other side is a door back end side. An open state wherein the hanging door M is spaced from a door frame is a first state, and a closed state wherein the hanging door M is completely moved into a movement end position is a second state. As shown in FIG. 1, in the door header W, there is fixed the rail 10.

The rail 10 shown in FIG. 1 and FIG. 2 is disposed along the slide direction. The rail 10 is formed, for example, by bending a metal plate, and includes an upper face portion 10a fixed to a lower face of the door header W; a pair of side face portions 10b extending downward from both ends in a Y direction of the upper face portion 10a; a pair of inside protruding portions 10c facing inward from a lower end of the side face portions 10b; and a slit 10d opening downward.

Between the pair of side face portions 10b of the rail 10, there is formed a housing portion 10e housing the closer 12 along the slide direction. The housing portion 10e is formed along the slide direction, and is communicated with an outside through the slit 10d. A pair of hanging wheels 20 (hanging tools) is disposed to run inside the housing portion 10e.

On the upper face portion 10a of the rail 10 for a hanging door, there is provided the striker 11 in a fixed position from an end. The striker 11 includes an engagement projection 11a protruding downward. By a movement of the hanging door M, the engagement projection 11a is captured by a catcher 32 so as to be engaged with a latch 30 and enter into the closer 12, or come out of the closer 12 to be released.

Hanging wheels 20A and 20B comprise a base 21 (a base portion) fixed on the hanging door M, and a plurality of rollers 22 axially supported on the base 21 rotatably. The base 21 comprises a column-shaped rod 23 whose lower end portion is fixed on the hanging door M, protruding upward, and disposed in such a way as to reach the housing portion 10e through the slit 10d; and a support piece 24 fixed on an upper end of the rod 23, and extending to both sides along the slide direction inside the housing portion 10e.

The hanging wheel 20A on one side is engaged to run along the rail 10, suspends one end side of the hanging door M, and is connected to the housing 40 inside the rail 10. The support piece 24 of the hanging wheel 20A integrally comprises a fixation portion 24a fixed in, for example, the rod 23; axis-support portions 24b and 24b formed on both sides of the fixation portion 24a; and a hinge receiving portion 24c formed on a back end side in the slide direction.

The hanging wheel 20B on the other side is engaged to run along the rail 10, and suspends the other end side of the hanging door M. The support piece 24 of the hanging wheel 20B integrally comprises the fixation portion 24a fixed in, for example, the rod 23; and the axis-support portions 24b and 24b formed on both sides of the fixation portion 24a.

In the axis-support portions 24b and 24b, there is respectively fixed axis bodies 25 having an axial center along the Y direction. On both ends in the Y direction of the two axis bodies 25, there are axially supported the respective rollers 22 rotatably.

As for the rollers 22, in the two axis bodies 25 and 25 aligned in the slide direction, a pair of rollers 22 and 22 is disposed respectively in the Y direction, and a total of four rollers 22 is provided. A predetermined gap is formed between the pair of rollers 22 and 22 in the Y direction, and the striker 11 can pass through therebetween.

The hinge receiving portion 24c provided in the hanging wheel 20A on one side includes a pair of receiving pieces 24d and 24d having a C shape in a plan view, and facing each other in the Y direction. An oscillation axis 26 crosses between the pair of receiving pieces 24d and 24d along the Y direction. In the oscillation axis 26, there is turnably mounted an oscillation body 45 of the housing 40, and the housing 40 is pivotally connected to the base 21. By the hinge receiving portion 24c, the oscillation axis 26, and the oscillation body 45, a hinge mechanism 35 is formed as a connection portion.

On an inside surface of an opening of the hinge receiving portion 24c, there is formed a tapered guide face 24e whose one end side is broadened, and at a support portion of the axis body 25, there is included a concave portion 24f whose opening is broadened in a semicircular shape. By the guide face 24e and the concave portion 24f, an assembly is facilitated, and a high engagement force can be obtained.

The closer 12 is connected to the base 21 to swing through the hinge mechanism 35 as the connection portion. Even in a case wherein the base 21 of the hanging wheel 20A is distorted by a load of the hanging door M so as to generate an inclination, by an oscillation of the hinge mechanism 35, the inclination on a base 21 side is absorbed, so that the inclination is not transmitted to a closer 12 side. Consequently, even if the base 21 of the hanging wheel 20A is distorted by the load of the hanging door M, the closer 12 maintains a horizontal posture.

The closer 12 includes the housing 40 as a base body provided to run inside the rail 10; the latch 30 as a contact body housed in an end portion at one side in a first direction of the housing 40, and supported to reciprocate between a standby position and a retracted position; an urging mechanism 50 such as a coil spring and the like urging the latch 30 to a retracting side (the other side in the first direction) relative to the housing 40; and a braking mechanism 60 connected to the latch 30, and providing a resistance force to a slide movement of the latch 30 so as to buffer.

As shown in FIG. 1 or FIG. 2, the housing 40 opens an upper face, and has a slender box shape in the slide direction. The housing 40 includes a pair of side walls, and the latch 30 is held between the side walls of a front end portion. At the front end portion of the housing 40, there is integrally provided the oscillation body 45 protruding frontward, and axially supported on the hinge receiving portion 24c. Namely, the front end portion of the housing 40 is connected to the base 21 of the hanging wheel 20A on one side through the hinge mechanism 35.

In the housing 40, there is formed a guide slit 44, the latch 30 is guided by the guide slit 44 to move, and by turning and moving straight, a standby posture and a retracted posture can be switched. The guide slit 44 continuously includes a main guide 44a along the slide direction, and a standby guide 44b bent downward from the main guide 44a.

At a back end portion of the housing 40, there is connected a back end portion 51b of a tensile coil spring 51 as an urging device. Also, in a lower portion of a back end of the housing 40, there is axially supported an auxiliary roller 48 rotatably. The auxiliary roller 48 is disposed to run on an upper face of the inside protruding portion 10c of the rail 10, and by the auxiliary roller 48, the back end of the housing 40 is supported to run relative to the rail 10.

The latch 30 includes a latch base 31 reciprocating in the first direction along the guide slit 44 of the housing 40, and a catcher 32 connected turnably around an axial center C1 at a front end of the latch base 31.

The latch base 31 is housed in an upper portion of the housing 40, and moves in the slide direction by being guided by the guide slit 44. In a lower portion of the latch base 31, there is connected a front end portion 51a of the tensile coil spring 51, which is always urged in a retracting direction.

Furthermore, on a back end face of the latch base 31, there is connected a piston damper 60, and a movement of the latch base 31 is damped.

The catcher 32 is turnably connected to the latch base 31, and has a hook shape whose upper side is open. The catcher 32 is guided by the guide slit 44 together with the latch base 31, and reciprocates between the standby position and the retracted position. Also, in the standby position, the catcher 32 turns around the axial center C1 along the Y axis relative to the latch base 31 so as to be engaged with or disengaged from the striker 11.

The urging mechanism 50 is formed by, for example, the tensile coil spring 51. The tensile coil spring 51 is disposed in such a way that an axial direction runs along the slide direction at a lower portion inside the housing 40. One end 51a of the tensile coil spring 51 is connected to the catcher 32, and the other end 51b of the tensile coil spring 51 is connected to the housing 40.

In the tensile coil spring 51, when the movable body M is moved to one side (frontward), the latch 30 in which the striker 11 is captured is pulled relatively to the other side (backward) relative to the housing 40, so that the hanging door M is forcibly moved frontward relative to the rail 10 and the door header W.

The braking mechanism 60 is formed by the piston damper 60 provided inside an upper chamber of the housing 40. The piston damper 60 includes a cylinder 61 in which a fluid is enclosed inside; a piston (not shown in the figures) reciprocating on a moving center line of the latch 30 inside the cylinder 61; and a piston rod 62 connected to the piston. A back end portion of the piston rod 62 is connected to the housing 40, and a front end portion of the cylinder 61 is connected to the back end face of the latch base 31. The braking mechanism 60 provides a resistance force of the fluid inside the cylinder 61 relative to pushing and pulling operations of the piston rod 62 relative to the cylinder 61 so as to damp an operation of the hanging door M.

In the movable body assist device 1 formed as above, the housing 40 is supported to swing (incline) through the hinge mechanism 35 relative to the base 21 of the hanging wheel 20A. Namely, the load of the hanging door M acts on a contacting portion between the support piece 24 connected to the rod 23 and the inside protruding portions 10c of the rail 10; however, by the hanging wheel 20A and the hinge mechanism 35 rotatable in a joint portion of the closer 12, a suspension structure can be established.

Therefore, by its own weight of the closer 12, the auxiliary roller 48 provided at the back end portion of the housing 40 of the closer 12 is maintained to always contact with the rail 10 and be supported. Consequently, even in a case wherein the base 21 of the hanging wheel 20A tilts due to a load concentration, the tilting can be absorbed at the hinge mechanism 35, and the load is not transmitted to the closer 12 so as to prevent the closer 12 from being lifted upwardly, and to always hold a height position of the closer at a proper position. Therefore, a dimensional accuracy between the striker 11 and the closer 12 can be set with a high degree of precision.

With reference to FIG. 1, an operation of the movable body assist device 1 will be explained. In a stage before the hanging door M is moved forward into a self-propelled start position, as shown in FIG. 1 and FIG. 2, the catcher 32 is held in the standby guide 44b in front, and is in a state wherein the striker 11 is released.

When the hanging door M is moved forward up to the self-propelled start position, the striker 11 enters into the housing 40 from the front, and the catcher 32 is pressed backward against an urging force of the tensile coil spring 51 by being pressed by the striker 11 so as to turn in an R1 direction in FIG. 2. Also, the catcher 32 captures the engagement projection 11a, and engages the striker 11. At that time, the catcher 32 enters into the main guide 44a from the standby guide 44b, and comes into a slidable state relative the housing 40. Then, by being urged by the tensile coil spring 51, the latch 30 moves into the retracted position behind the housing 40 in a state wherein the striker 11 is captured. In association with the relative movement, the hanging door M runs by itself forward up to a stop position relative to the striker 11 and the support body W.

On the other hand, when the hanging door M is moved backward from the stop position, if the movable body M is moved, the latch 30 integrated with the striker 11 is relatively moved forward relative to the housing 40 while storing a force in the tensile coil spring 51, and in a stage wherein the movable body M reaches the self-propelled start position, the movable body M enters into the standby guide 44b of the housing 40, and the catcher 32 turns in an R2 direction. Thereby, the catcher 32 releases the striker 11, returns to the standby position, and the striker 11 and the latch 30 are separated. After that, a movement control of the hanging door M is released.

According to the movable body assist device 1 with respect to the present embodiment, the following effects are provided. Namely, in the movable body assist device 1, the housing 40 is supported to swing (incline) through the hinge mechanism 35 relative to the base 21 of the hanging wheel 20A so as to establish the suspension structure, and even in the case wherein the base 21 of the hanging wheel 20A tilts due to the load concentration, the tilting can be absorbed at the hinge mechanism 35, and the load is not allowed to be transmitted to the closer 12. Consequently, by its own weight of the closer 12, the auxiliary roller 48 provided at the back end portion of the housing 40 of the closer 12 is maintained to always contact with the rail 10 and be supported so as to prevent the closer 12 from being lifted upwardly, and to always hold the height position of the closer at the proper position. Therefore, the dimensional accuracy between the striker 11 and the closer 12 can be set with the high degree of precision.

Incidentally, the present invention is not limited to the aforementioned embodiment, and can be variously modified provided that they do not exceed the subject of the present invention. Also, a specific structure, material, and the like of each portion are not limited to the aforementioned embodiment shown as the example, and can be appropriately modified.

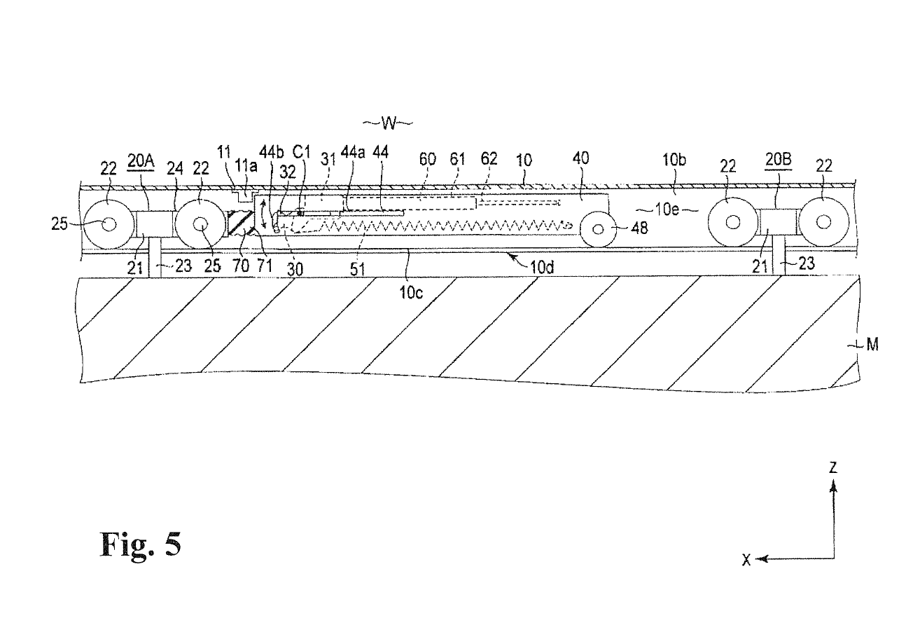

In the aforementioned embodiment, as the connection portion connecting between the housing 40 and the base 21, the hinge mechanism 35 is shown as the example; however, the connection portion is not limited to the hinge mechanism 35. For example, as another embodiment, as shown in FIG. 5, in place of the hinge mechanism 35, the housing 40 and the base 21 may be connected through a connection portion 70 including an elastic portion 71 made of elastically deformable soft elastic materials such as rubber and the like. The connection portion 70 includes the deformable elastic portion 71, and connects the housing 40 relative to the base 21 of the hanging wheel 20A, and by a deformation of the elastic portion 71, displacement and tilting of the base 21 are absorbed. Even in that case, by the connection portion 70, the suspension structure is established, and due to the load concentration, the inclination or displacement of the base 21 of the hanging wheel 20A can be absorbed at the connection portion 70, and the load is not transmitted to the closer 12. Consequently, by its own weight of the closer 12, the auxiliary roller 48 provided at the back end portion of the housing 40 of the closer 12 is maintained to always contact with the rail 10 and be supported so as to prevent the closer 12 from being lifted upwardly, and to always hold the height position of the closer at the proper position. Therefore, the dimensional accuracy between the striker 11 and the closer 12 can be set with the high degree of precision.

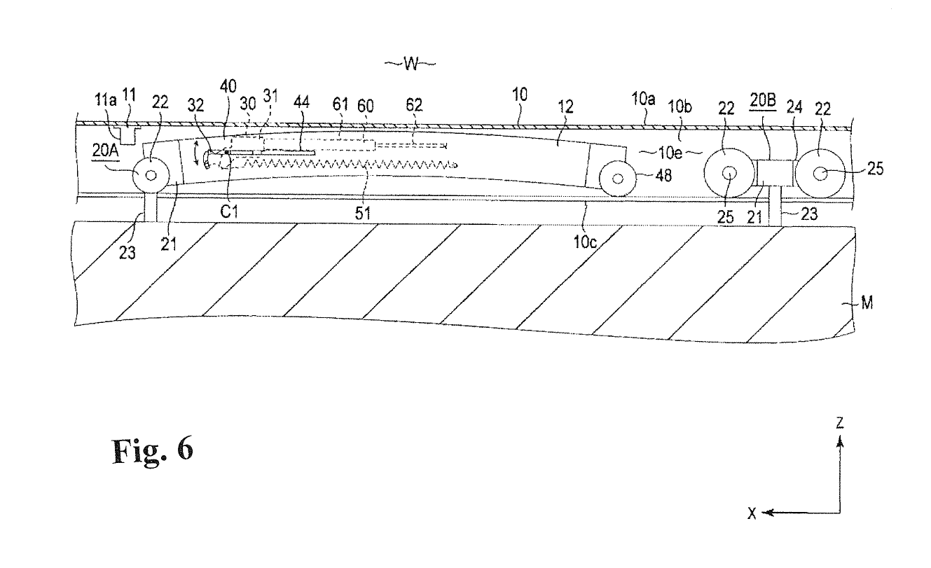

In the aforementioned embodiment, the example of connecting the housing 40 and the base 21 through the hinge mechanism 35 has been shown; however, the embodiment is not limited to the example. For example, as another embodiment, as shown in FIG. 6, the base 21 and the housing 40 may be integrally fixed, and formed to be curved in an arched shape. In that case, with a state wherein the hanging roller 22 and the auxiliary roller 48 on one end side of the housing 40 spaced from the hanging roller 22 in the first direction are supported on the rail 10, and in a state wherein the load is not applied, a center portion between the rollers 22 and 48 is disposed to be spaced from the rail 10. By the arched shape, even in the case wherein the base 21 of the hanging wheel 20A tilts due to the load concentration, the displacement in the up-and-down direction can be absorbed at the arch-shaped housing 40, and by its own weight of the closer 12, the auxiliary roller 48 provided at the back end portion of the housing 40 of the closer 12 is maintained to always contact with the rail 10 and be supported. Therefore, the position or posture of the closer 12 can be always held properly, and the dimensional accuracy between the striker 11 and the closer 12 can be set with the high degree of precision.

In the aforementioned embodiment, a case wherein the latch 30 is provided only on one side of the housing 40, and performs an assist operation in one direction has been shown as the example; however, the embodiment is not limited to the above. For example, the latch 30 may be provided on both ends of the housing 40, and the striker 11 may be provided respectively on right-and-left both sides of the rail 10 so as to assist operations in both directions on the door front end side and the door back end side. In that case, for example, both ends of the tensile coil spring 51 are respectively connected to latch bases 31 on both sides, and end portions of the cylinder 61 and the piston rod 62 of the piston damper 60 are respectively connected to the respective latch bases 31 on both sides, so that a common mechanism can be used for assisting and damping the latches 30 on both sides.

Also, as for the catcher 32, the hook-shaped catcher which engages by turning and captures has been shown; however, the catcher 32 may have other structures such as a structure clamping an axial striker between a pair of holding pieces, and the like.

Also, in the aforementioned embodiment, as for the hanging rollers 22, the embodiment providing a total of four hanging rollers 22 in two rows is shown as the example; however, the hanging rollers 22 are not limited to the above, and for example, as shown in FIG. 7, the hanging rollers 22 may have a structure of supporting by a pair of rollers 22.

For example, in the aforementioned embodiment, the case wherein the closer 12 is provided on the hanging door M side as the movable body, and the striker 11 is provided on the rail 10 as the support body or a door header side has been shown as the example; however, the embodiment is not limited to the above, and the striker 11 can be provided on the movable body M side, and the closer 12 can be provided on a support body side, respectively.

Furthermore, even if one portion is omitted among the structural requirements of the aforementioned embodiments, the present invention can be implemented.

Incidentally, all contents of the specification, claims, drawings, and abstract of Japanese Patent Application No. 2012-082754 filed on Mar. 30, 2012 are cited in their entireties herein and are incorporated as a disclosure of the specification of the present invention.

1. A movable body assist device comprising:
a contact receiving body provided in one of either a support body or a movable body relatively moving to the support body;
a base body supported on a rail provided in one of either the support body or the movable body relatively moving to the support body;
a hanging wheel including a base provided in the other of either the support body or the movable body, and a roller supported in the base and rotatably moving inside the rail, and suspending the other of either the support body or the movable body movably on the rail;
a contact body formed to reciprocate in a first direction relative to the base body, and formed to engage with and disengage from the contact receiving body;
an urging mechanism urging the contact body; and
a connection portion connecting the base body to oscillate relative to the base of the hanging wheel.

2. A movable body assist device according to claim 1, wherein the connection portion includes a hinge mechanism axially supporting the base and the base body to swing around an axis intersecting in the first direction.

3. A movable body assist device according to claim 2, wherein the hinge mechanism includes:
a receiving portion provided in one end side in the first direction of the base, and opening at the one end side;
an oscillation portion axially supported to oscillate in the opening of the receiving portion, and connected to the base body; and
an axis body passing through a rotating portion, and bridged to the opening of the receiving portion.

4. A movable body assist device according to claim 3, wherein an inside face of the opening of the receiving portion forms a guide face having one end side broadened.

5. A movable body assist device, comprising:
a contact receiving body provided in one of either a support body or a movable body relatively moving to the support body;
a base body supported on a rail provided in one of either the support body or the movable body relatively moving to the support body;
a hanging wheel including a base provided in the other of either the support body or the movable body, and a roller supported in the base and rotatably moving inside the rail, and suspending the other of either the support body or the movable body movably on the rail;
a contact body formed to reciprocate in a first direction relative to the base body, and formed to engage with and disengage from the contact receiving body;
an urging mechanism urging the contact body; and
a connection portion having a deformable elastic portion, connecting the base body relative to the base of the hanging wheel, and absorbing a displacement of the base by a deformation of the elastic portion.

6. A movable body assist device, comprising:
a contact receiving body provided in one of either a support body or a movable body relatively moving to the support body;
a base body supported on a rail provided in one of either the support body or the movable body relatively moving to the support body;
a hanging wheel including a base provided in the other of either the support body or the movable body, and a roller supported in the base and rotatably moving inside the rail, and suspending the other of either the support body or the movable body movably on the rail;
a contact body formed to reciprocate in a first direction relative to the base body, and formed to engage with and disengage from the contact receiving body; and
an urging mechanism urging the contact body,
wherein in a state in which the base and the base body are integrally fixed, and the hanging roller and one end side of the base body spaced from the hanging roller in the first direction are supported on the rail, a center portion therebetween is formed to be curved in an arched shape in such a way as to be disposed by being spaced from the rail.

7. A movable body assist device according to claim 1, wherein at least a pair of hanging tools is provided in the movable body, and the base body is connected to either of the hanging tools,
an auxiliary roller running along the rail is provided in the other end of the base body, and
the hanging roller and the auxiliary roller are supported on the rail.

8. A movable body assist device according to claim 1, wherein the urging mechanism includes a tensile coil spring having one end connected to the contact body and another end connected to the base body, and the contact body capturing the contact receiving body is moved by a tensile force of the tensile coil spring in a retracting direction so as to forcibly move the movable body relative to the support body.

9. A movable body assist device according to claim 1, further comprising a braking mechanism connected to the contact body, and damping an operation of the contact body,
wherein the braking mechanism is a piston damper including a cylinder and a piston rod, and provides a resistance force of a fluid inside the cylinder relative to pushing and pulling operations of the piston rod relative to the cylinder.

10. A movable body assist device according to claim 1, wherein the contact body includes a catcher supported in the base body slidably between a standby position and a retracted position, and engageable with and disengageable from the contact receiving body, and
the catcher is held in the standby position of the base body in an engagement releasing state, and in an engagement state in which the contact receiving body is captured, retention is released so as to be slidable by the urging mechanism.
